(19) United States
(12) Patent Application Publication
(10) Pub. No.: US 2007/0183151 A1
(43) Pub. Date: Aug. 9, 2007

(54) ELECTRICAL LIGHTING SYSTEM

(75) Inventor: Mark Joseph, Aspen, CO (US)

Correspondence Address: GLENN L. WEBB, P.O BOX 951, CONIFER, CO, 80433, US

(73) Assignee: LITESNOW, INC., Aspepn, CO (US)

(21) Appl. No.: 11/307,467

(22) Filed: Feb. 8, 2006

(51) Int. Cl. B60Q 1/26

(52) U.S. Cl. 362/232

(57) ABSTRACT

An electrical lighting system for mounting to a surface. The lighting system includes an electrical power supply that is mounted by adhesive backing to a surface. Light fixtures use piercing connectors to pierce the electrical power supply and engage the electrical leads to provide power to the light fixtures. The light fixtures are held in place by adhesive.

### FIELD OF THE INVENTION

This invention relates to the field of electrical lighting systems and particularly to the field of lighting systems mountable under cabinets, task lighting and other types of lighting systems.

### BACKGROUND OF THE INVENTION

It is often desirable to mount lights under cabinets, on shelves, in dark corners, on display cabinets and many other locations where lights were not originally mounted or where overhead lighting is not adequate. These types of lighting systems, whether undercabinet lights, task lighting or other lighting systems are often necessary after the structure on which they are being used has been built. The mounting surfaces for these lighting systems are also often in inconvenient locations that require contortions to be able to install the lighting systems. The current lighting systems are usually relatively difficult to install the electrical cables and the lighting fixtures within the structure. Also, the installed lighting system often has unattractive exposed cables, connectors and switches.

Another problem with these prior types of lighting systems is that they are not able to be adjusted once they are installed. The inability to adjust the direction of the light often fails to solve the problem for which the lighting system was initially installed. Also these types of lighting systems are usually able to be installed in a singular orientation without the flexibility to provide an adequate lighting solution.

These lighting systems are relatively difficult to install, requiring electrical and mechanical skills as well as a collection of tools to accomplish the installation. These systems often require the services of an electrician or carpenter thus adding to the cost of installation of these systems.

Thus a need exists for an adjustable lighting system that can be easily installed in numerous configurations without the need for electrical or mechanical skills or tools.

### SUMMARY OF THE INVENTION

The present invention solves these and other problems by providing a lighting system that can be easily and quickly installed by most individuals. The lighting system can be installed in numerous surfaces and orientations and allows the light direction to be adjusted after installation.

The system of the present invention in a preferred embodiment uses an electrical power tape system. This power tape system provides two parallel electrical leads carried in an insulative material. An adhesive strip is attached to one side of the insulative material to allow the power tape to be securely attached to any mounting surface. The power tape connects on one end to an electrical power source, such as a transformer/switch to provide electrical current to the electrical leads. The power tape is flexible and can be easily wrapped and bent around complex surfaces often found under cabinets. The Power tape can also be pinched and bent by hand to form corners that allow the Power tape to change direction. The power tape eliminates the need to run electrical cables to the lighting fixture location. The power tape may be painted to match or accent the mounting surface. The adhesive strip on the power tape allows the power tape to adhere around corners and over obstructions so the power tape can be applied to almost any surface or location.

A preferred embodiment of the present invention provides light fixtures that connect directly to the power tape. The light fixtures include piercing points on the lamp socket leads. The light fixtures are pressed directly onto the power tape until the piercing points penetrate the insulative materials and engage the electrical leads. This provides electrical current to the light fixtures. The light fixtures can be mounted at any location along the power tape.

The light fixtures of a preferred embodiment include an attachment base that engages over the power tape. A non-conductive tab slides under the power tape beneath the point where the piercing points are inserted. This tab serves two purposes. First it prevents the piercing points from being exposed should they over penetrate the power tape. Secondly, it helps to align and mount the light fixture to the power tape. The attachment base may also include adhesive strips and/or screw mounting holes for further attaching the light fixture to the mounting surface.

The light fixtures of a preferred embodiment also includes a pivotable base that allows the lamp sockets to swivel relative to the mounting surface. This allows the light source to be adjusted to direct the light to a desired location. The light fixtures may also include rotatable lamp shrouds to further adjust the light to a desired location.

These and other features will be evident from the ensuing detailed description of preferred embodiments and from the drawings.

### BRIEF DESCRIPTION OF THE DRAWING

FIG. 1 is an illustration of an installed lighting system of a preferred embodiment of the present invention.

FIG. 2 is a perspective cut-away illustration of the power tape of the embodiment of FIG. 1.

FIG. 3 is a side view of the light fixture of the embodiment of FIG. 1.

FIG. 4 is an exploded view of the light fixture of FIG. 3.

FIG. 5 is a cross-sectional view of the light fixture of FIG. 3.

FIG. 6 is a perspective view of the light fixture of FIG. 3 being installed on the power tape of FIG. 2.

FIG. 7 is a cross-sectional view of the light fixture of FIG. 3.

FIG. 8 is another view of the lighting system of FIG. 1.

FIG. 9 is a close-up view of the lighting system of FIG. 1.

FIG. 10 is an opposing view of the lighting system of FIG. 1.

FIG. 11 is a view of the light fixture of FIG. 3 in a swiveled position.

FIG. 12 is a view of the light fixture of FIG. 3 with the shrouds rotated.

FIG. 13 is a view of an alternative embodiment of the light fixture of FIG. 3.

FIG. 14 is a view of an alternative embodiment of the light fixture.

FIG. 15 is a close up view of the light fixture without the adjustable shade installed of the embodiment of FIG. 14.

FIG. 16 is another view of the fixture of FIG. 14 being mounted to the power tape.

### DESCRIPTION OF PREFERRED EMBODIMENTS

The present invention provides electrical lighting systems and components for under cabinet, task and other lighting systems. It is to be expressly understood that the descriptive embodiments set forth herein are intended for explanatory purposes and is not intended to unduly limit the scope of the claimed inventions. Other embodiments and applications not described herein are considered to be within the scope of the invention. It is also to be expressly understood that while specific embodiments for the components of the electrical track lighting systems are discussed, other equivalents to these embodiments that perform substantially similar functions are within the scope of the claimed inventions.

Preferred Lighting System

The present invention relates to the subject matter of U.S. patent applications Ser. No. 10/905,220, filed on Dec. 22, 2004, Ser. No. 10/378,450 filed on Mar. 30, 2003 and Ser. No. 09/920,569, filed on Jul. 31, 2001, now issued as U.S. Pat. No. 6,540,372, the subject matter are incorporated herein by reference.

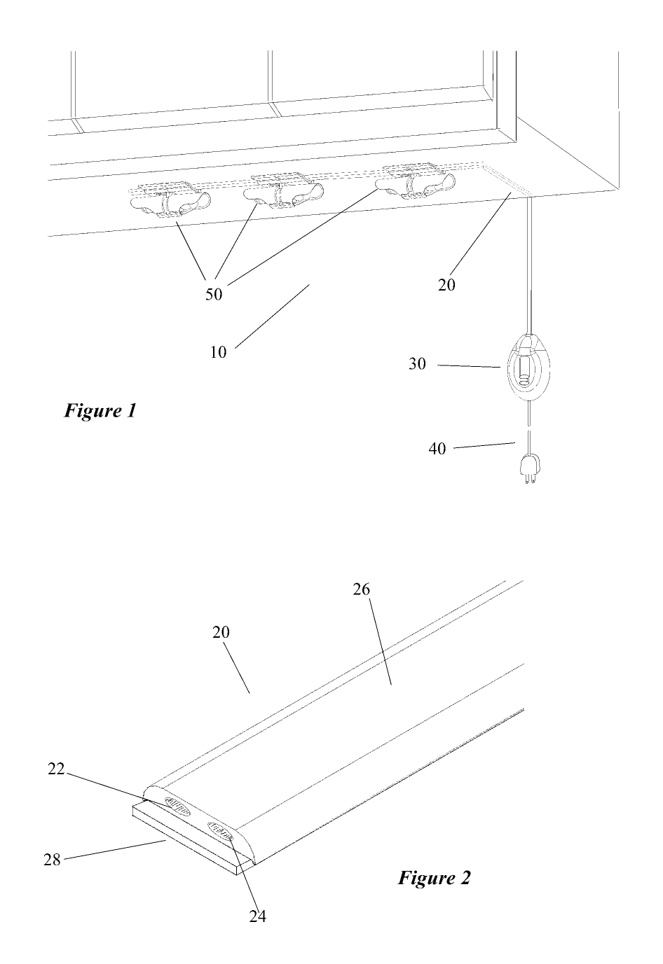

A preferred embodiment of the present invention is illustrated in FIGS. 1-12. The lighting system 10 of this preferred embodiment as shown in FIG. 1 has particular utility for under cabinet lighting, for task lighting, for display lighting and many other applications. The lighting system 10 of this embodiment includes power tape 20, light switch/transformer 30, electrical power cord 40 and light fixtures 50. These components may be usable in other configurations with all or part of the other components. These components in this preferred embodiment provide a low profile, attractive lighting system that can not only be mounted in many different locations and orientations but also may be reoriented in different configurations to direct light in different desired locations.

The power tape 20 of this preferred embodiment is shown in detail in FIG. 2. The power tape 20 includes flattened electrical leads 22, 24 carried in an insulated strip 26. The power tape 20 is made as thin as possible and includes upper radiused corners to cause it to blend into the applied surface. It is paintable by most common household paints. This provides an unobtrusive electrical system that can be painted to match the surfaces that the tape is mounted onto or to accent those surfaces.

The power tape 20 also includes an adhesive strip 28 attached to the bottom of the power tape. This adhesive may include a soft foam interior to improve conformity to uneven or textured surfaces. The adhesive strip 28 includes a release liner on its exterior surface to prevent attachment until the tape is ready to be attached to the mounting surface. The power tape 20 is designed so that it can be easily cut with scissors and securely mounted to a surface with the adhesive strip 28. The use of the adhesive strip 20 provides full support along the entire length of the strips 12. This ensures that there will not be stress points along the power tape, and there is no need to attempt to locate studs, rafters or other support members in the surface for attachment. Also, there is no need to drill and/or install anchors in the surface. The bendable property of the strips allow them to be installed over complex surfaces, around corners, even wrapped around vertical and horizontal beams and other surfaces including uneven surfaces. These systems can not only be used in household areas, but in commercial areas, trade shows and with the appropriate precautions, outdoors. These systems can be permanently installed or used as temporary lighting as well. There is no need for professional installation as these systems can be installed with little mechanical aptitude or even any tools. The power tape may also be painted to match or accent the mounting surfaces.

The power tape 20 is attached on one end to the transformer/switch 30. In a preferred embodiment, the transformer switch 30, as described co-pending application Ser. No. 10/905,220 incorporated herein by reference, enables the power tape to be trimmed to a desired length and then inserted into the transformer/switch 30 for connection to electrical power. It is to be expressly understood that other types of transformers may be used with the present invention as well as switches, both in combination with one another and separately. The transformer/switch 30 also includes an adhesive backing to enable it to be attached to a mounting surface. The transformer/switch 30 also includes a connection to an electrical power cord 40 with a standard electrical plug that is plugged into an available electrical outlet. It is also to be expressly understood that the switch 30 can be directly hardwired into available electrical power sources.

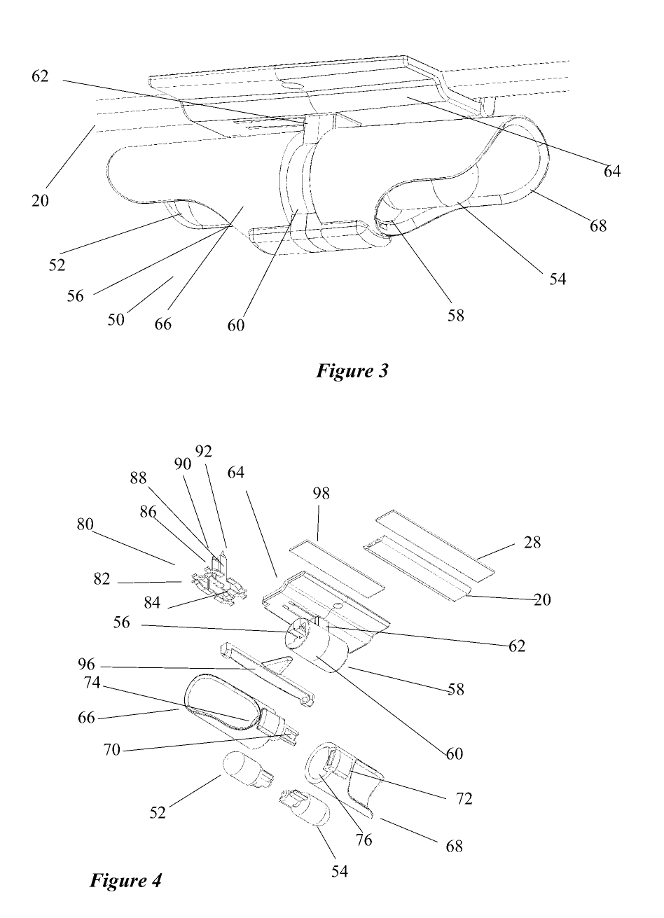

The light fixtures 50 attach directly to power tape 20 as described in greater detail below. The light fixtures 50, as shown in FIGS. 3-12, include opposing light bulbs 52, 54 that engage in sockets 56, 58. The sockets 56, 58 are standard light sockets capable of holding standard bulbs 52, 54. The sockets 56, 58 are mounted within housing 60, as shown in FIG. 4. The housing 60 is mounted on pivoting base 62 that is mounted on attachment base member 64. The housing 60 is thus able to pivot relative to attachment base member 64 about the axis of pivoting base 62. It is also to be expressly understood that other types of light configurations may be implemented under the present invention including but not limited to using a single light bulb and socket embodiment. It is also to be understood that a rigid base 62 may be used in lieu of the pivoting base described above.

Lamp shrouds 66, 68 are used to direct the light from the bulbs 52, 54 to a desired location. The lamp shrouds 66, 68 include inner portions 74, 76 shown in FIG. 4 that engage over the outer surface of housing 60. Lamp shroud 66 includes a female attachment member 70 that is engaged by male attachment member 72 on lamp shroud 68. The engaged lamp shrouds 66, 68 are thus able to rotate relative to housing 60 and the bulbs 52, 54.

The light fixture 50 also includes electrical connection mechanism 80. The electrical connection mechanism 80 includes electrical clips 82, 84 that are mounted within the sockets 56, 58 to supply electrical current to the light bulbs 52, 54. The electrical clips 82, 84 include electrical leads 86, 88 that end in sharp piercing points 90, 92 that extend through the attachment base member 64. In another preferred embodiment the electrical leads 86, 88 are flexible to enable the base 60 to be able to pivot relative to the attachment base member 64 without disengaging from the power tape 20 as discussed in greater detail below.

Tab 96 is pivotally mounted to the attachment base member 64 as shown in FIG. 6. In this preferred embodiment, the tab 96 is aligned with the piercing points 90, 92 of the electrical leads 86, 88. The tab 96 is also formed in a tapered shape to enable it to more easily slide under the power tape 20 as discussed below. An adhesive strip 98 is mounted on the opposing side of the attachment base member 64.

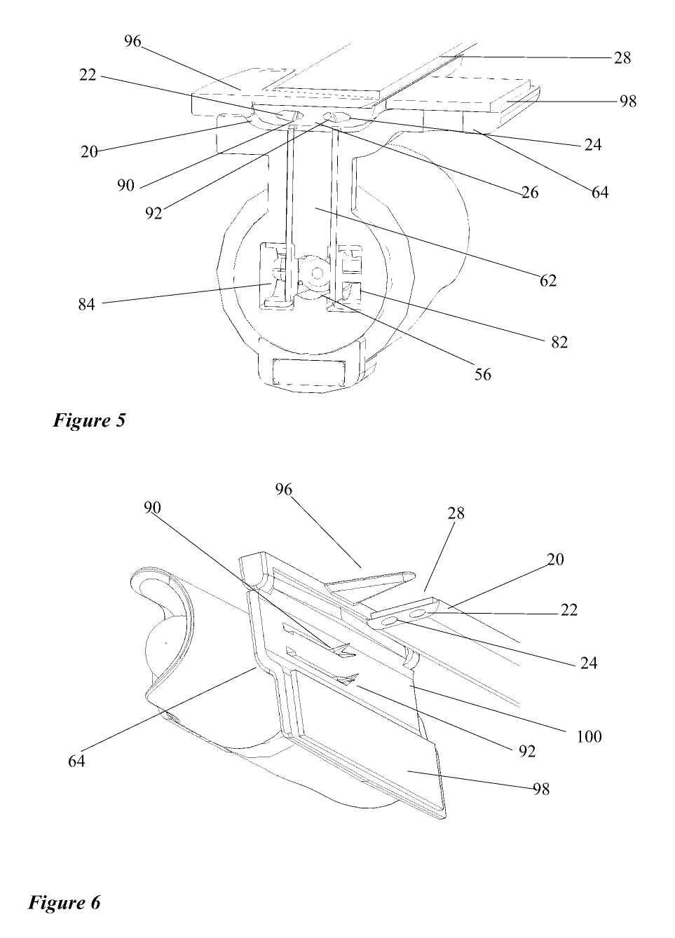

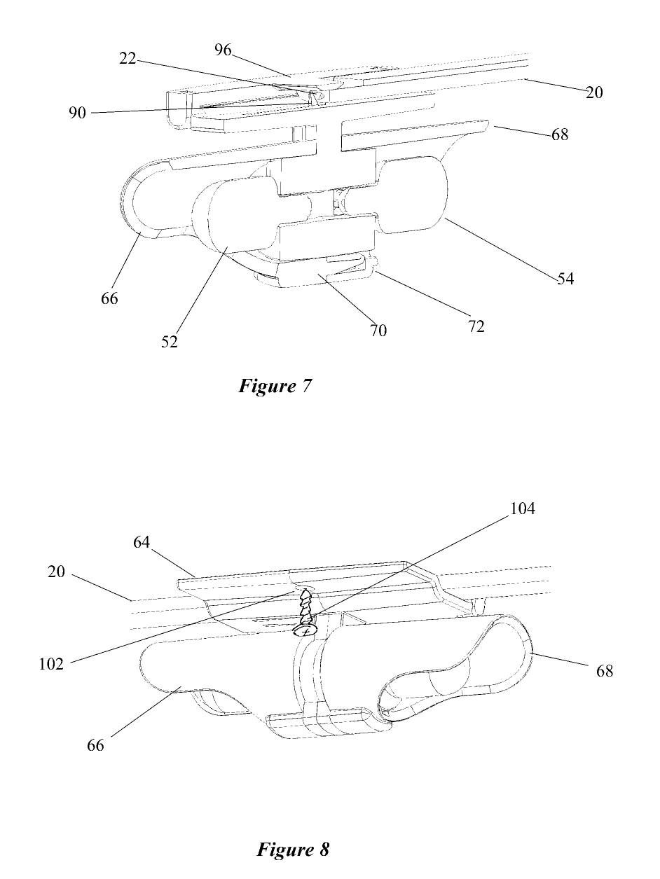

The lamp fixture 50 is secured directly onto the power tape by engaging the tab 96 underneath the adhesive strip 28 by separating the foam layer of the adhesive tape. The tapered sharp edged form of the tab 96 enables this to be easily done without damaging the power tape. The foam based adhesive strip 28 is also able to compress sufficiently that the power tape is not significantly raised from the mounting surface. As shown in FIG. 6, the fixture 50 is pivoted away from the power tape 20 at this point. Once the tab has been fully inserted under the power tape 20, the light fixture is properly aligned to connect properly anywhere along the power tape. The light fixture 50 is pivoted downward onto the power tape. The power tape will fit within recess 100 on the attachment base member. As the light fixture 50 engages against the power tape, the piercing points 90, 92 pierce the insulation on the power tape. The piercing points will then engage in the flattened electrical leads which are comprised of a bundle of tiny copper wires or a flat thin penetratable solid copper strip 22, 24 to make an electrical connection between the electrical leads 22, 24 of the power tape and the electrical leads 86, 88 of the light fixture as shown in FIGS. 5 and 7. The tab 96 prevents the piercing points 90, 92 from further exposing the electrical leads to minimize the possibility of electrical shorts or damage to the mounting surface.

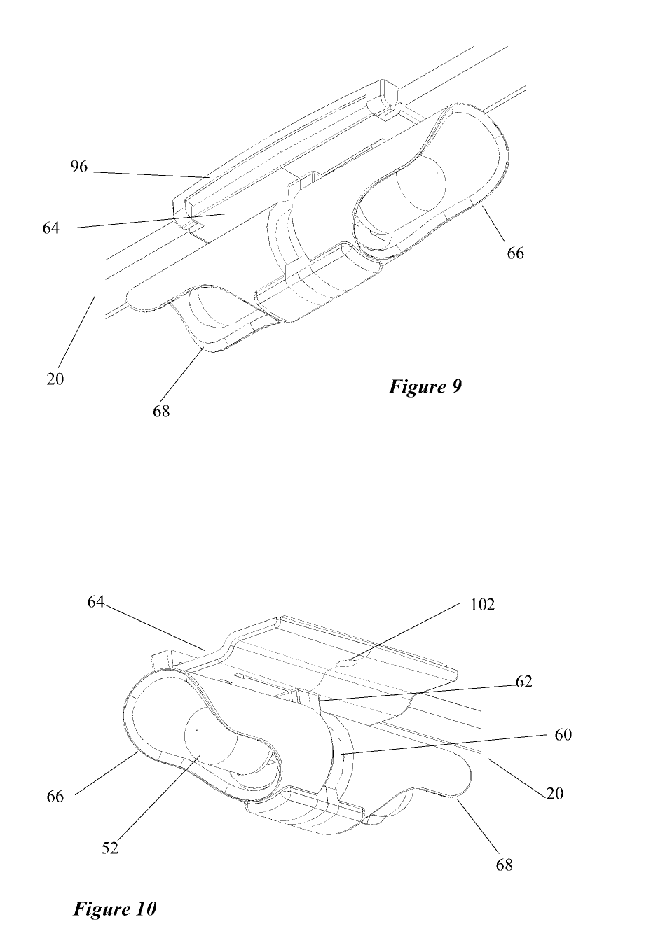

The light fixture 50 is securely fastened to the power tape and mounting surface by the adhesive strip 98. Once the above mounting steps above are done, the light fixture is rotated back open so the paper backing on the adhesive tape 98 can be removed and applied by closing the light fixture. If additional mounting strength is desired, a screw mounting hole 102 is provided in a preferred embodiment, shown in FIG. 8 with screw 104. The light fixture 50 is then securely mounted and ready for use, as shown in FIG. 9.

The use of the piercing electrical connection of the light fixture to the power tape enables the placement of the light fixtures at any point on the power tapes. This unique attachment system also eliminates the need for additional mounting hardware or for exposed electrical tracks. The light fixtures can be quickly and easily attached to the power tape without the need for tools or expertise.

The light fixture 50 can be quickly removed and moved to another location. The fixture is pulled and pivoted away from the mounting surface, thus causing the piercing points of the electrical leads 86, 88 to disengage from the electrical leads of the power tape. The tab is slipped away from beneath the adhesive strip of the power tape and the fixture remounted at another location. The insulation of the power tape is sufficiently resilient to close the exposed holes from the piercing points, or else electrical tape or other insulative material may be used to cover any exposed holes.

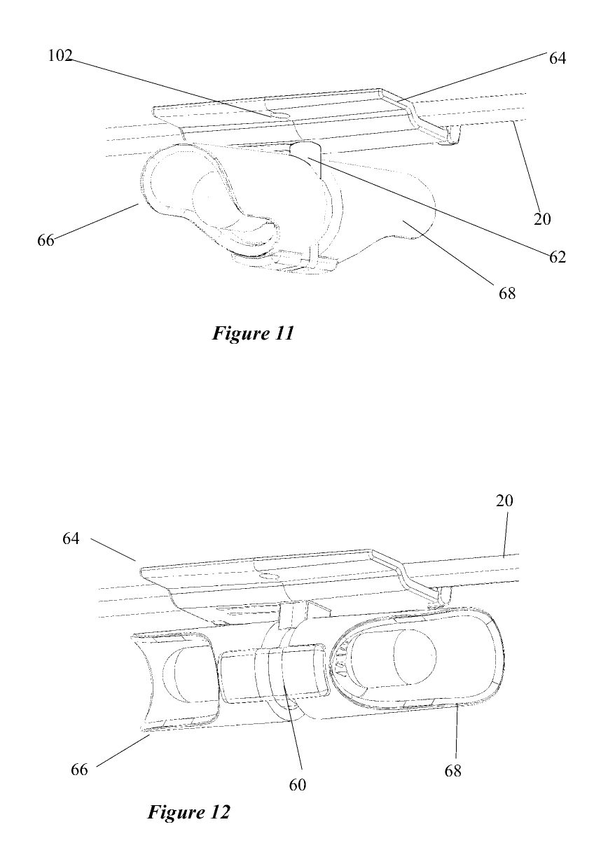

In use, the light fixture can be adjusted to direct the light to the desired locations. The light fixture as shown in FIG. 10 can be mounted parallel to the longitudinal axis of the power tape. It can then be pivoted about the central axis of the base 62 as shown in FIG. 12 to enable the light to be directed in that manner. The lamp shrouds 66, 68 can also be rotated about the bulbs as shown in FIG. 12 to further direct the light. This dual action of directing the light along with the ability to place the power tape at almost any location and mounting the light fixture at any location along the power tape provides an infinite number of possibilities of adjusting the light from the fixtures to any desired location. The shrouds can also be rotated to block the visibility of the lighted bulb while aiming the light away from the eyes.

Installation

The lighting system 10 can be provided in a do it yourself kit form or in industrial packaging. The system 10 will typically be supplied with a length of power tape 20, the transformer/switch 30, power cord 40 and a number of fixtures and bulbs rated for the transformer and power tape.

The user will simply cut the power tape to the desired length with scissors or a knife. The transformer/switch 30 is mounted at the desired location. The release liner is removed from the power tape and the adhesive strip on the power tape is pressed along the mounting surface, such as a wall, under cabinet surface, shelf or any other desired location. The end of the power tape is mounted and connected to the transformer/switch. The light fixtures are then mounted at their desired locations along the power tape. The tabs of the light fixtures are slipped underneath the power tape at the desired location and the light fixture is pivoted downward onto the power tape until the piercing connectors fully engage the electrical leads of the power tape. The adhesive strip on the light fixture is firmly pressed against the mounting surface and, if desired, the mounting screw is used to further attach the light fixture to the mounting surface. The power cord is then plugged into the available electrical outlet. It is to be understood that the steps can be done in other orders, such as plugging the power cord in earlier to ensure that the light fixtures are properly installed. The lighting system is now fully operable for use. The light fixtures can be pivoted for the best orientation for providing light to the desired location as well as the lamp shrouds rotated.

It is to be expressly understood that the above descriptive embodiment is provided for explanatory purposes only and other embodiments are within the scope of the claimed inventions.

### Alternative Embodiment

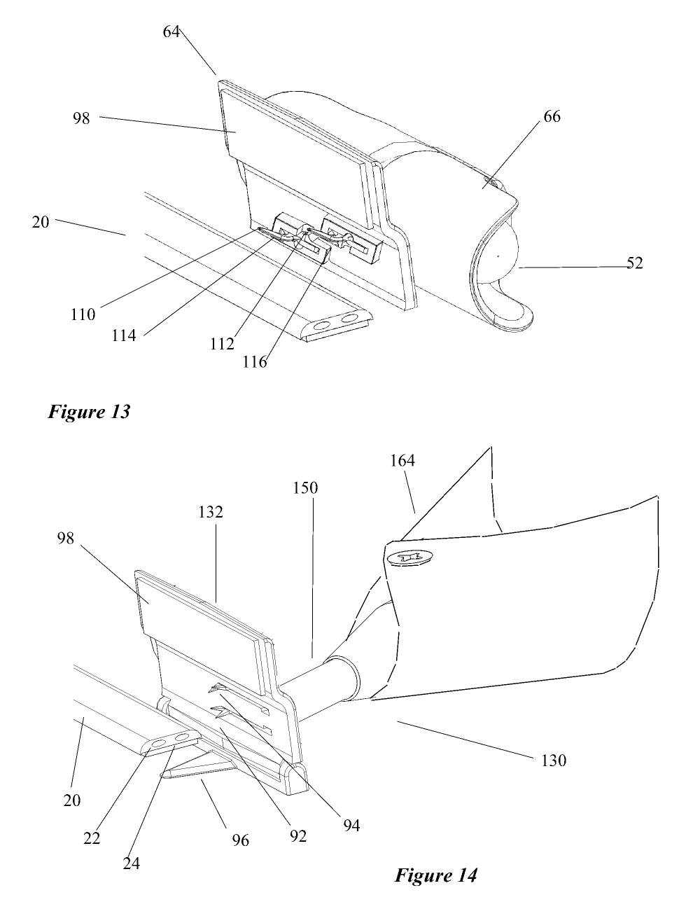

Another alternative embodiment is illustrated FIG. 13. This embodiment is similar to the above described embodiment except the piercing points 110, 112 on the electrical leads of the lamp fixture include a needle portion 114, 116, respectively extending perpendicular to the length of the fixture and parallel to the electrical leads 22, 24 of the power tape 20. The lamp fixture is secured to the power tape by angling the attachment base against the power tape to align the piercing members 110, 112 with the electrical leads of the power tape. Pressure is then applied to cause the piercing members to penetrate the insulation of the power tape and make conductive contact with the conductive wires. The piercing members pierce into the initial insulation, penetrate the conductive wires but do not pass through the insulation on the opposing sides. The perpendicular angle of the piercing members hold the fixture to power tape with the addition of an optional screw.

### Alternative Embodiment

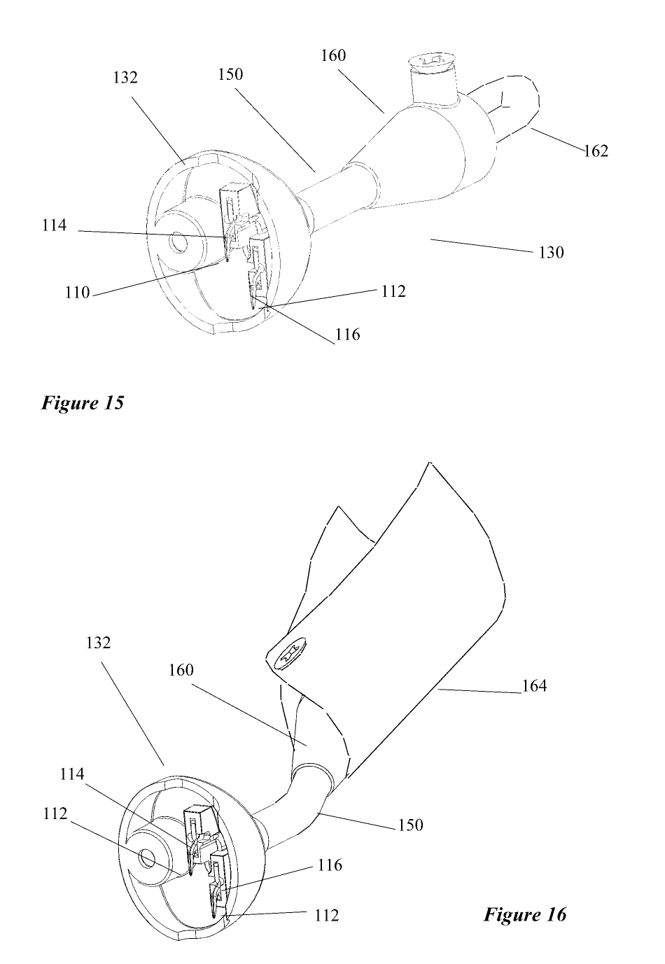

Another preferred embodiment of a track lighting system is illustrated in FIGS. 14-16. This track lighting system is mounted and used in the same manner shown in FIG. 1, or in another different connection means.

The fixture 130 of this preferred embodiment includes a base unit 132, a flexible shaft 150 and a lamp holder 160. The base unit 132 can include the mounting mechanism as discussed above using piercing members 90, 92 with the tab and adhesive strip mounting mechanism as shown in FIG. 14 or the alternative mounting mechanism using the piercing connectors 110, 112 with the parallel need portions 114, 116. Either of these piercing members are connected to power feed lines that extend from the base unit 132 through the flexible shaft 150 and connect to lamp holder 160. Recesses are formed in the upper surface of the base unit 132 and shaped to allow power tape 20 to fit partially therein.

The lamp holder 160 is a standard design and connects power feed lines to lamp socket 162 for receiving and powering a lamp bulb, such as a halogen or incandescent light bulb. Lamp shade 164 is also mountable to the lamp holder to diffuse light from the light bulb.

In use, the base unit 132 is secured to the power tape 40 by either of the mechanisms discussed above with piercing members engaging with the conductive wires of the power tape 20. Pressure is then applied in a lateral motion to cause the piercing members to slide in and penetrate the insulation of the power tape and make conductive contact with the conductive wires. The piercing members pierce into the initial insulation, penetrate the conductive wires but does not pass through the insulation on the opposing sides. The piercing members extending into the power tape parallel to the conductive wires hold the fixture to power tape 20. In other preferred embodiments, additional securing mechanism may be used, such as push pins or securing screws to provide additional security.

The light fixtures 130 may be mounted anywhere along the power tape 20 as desired. The flexible shaft of the light fixture and lamp shade 164 allow adjustment of the light from the light fixture to provide the best utilization of the light fixtures. In a preferred embodiment, the shade has a hinge to open and close around the light fixtures.

It is to be expressly understood that the above described embodiments are provided for explanatory purposes and do not limit the claimed inventions to only these features, either alone or in different combinations.

What is claimed is:

1. An electrical lighting system wherein said system comprises:
two parallel electrical leads mounted in an insulative material;
an adhesive strip mounted on one surface of said insulative material to secure said insulative material to a mounting surface;
a power source for supplying electrical power to said two parallel electrical leads;
at least one light fixture;
electrically conductive leads extending from said at least one light fixture; and
piercing points on said electrically conductive leads that pierce said insulative material to engage said two parallel electrical leads to provide electrical current from said two parallel electrical leads to said at least one light fixture.

2. The electrical lighting system of claim 1 wherein said system further comprises:
an attachment base on said light fixture for securing said light fixture to said insulative material.

3. The electrical lighting system of claim 1 wherein said system further comprises:
an attachment base on said light fixture for securing said light fixture to said insulative material; and
a non-conductive portion on said attachment base for protecting said piercing points in the event that said piercing points fully penetrate said insulative material.

4. The electrical lighting system of claim 1 wherein said system further comprises:
an attachment base on said light fixture for securing said light fixture to said insulative material; and
a non-conductive member pivotally attached to said attachment base for aligning and protecting said piercing points in the event that said piercing points fully penetrate said insulative material.

5. The electrical lighting system of claim 1 wherein said system further comprises:
an attachment base on said light fixture for securing said light fixture to said insulative material; and
an adhesive strip on said attachment base for securing said light fixture to a mounting surface.

6. The electrical lighting system of claim 1 wherein said system further comprises:
an attachment base on said light fixture for securing said light fixture to said insulative material;
a hole on said attachment base; and
a screw insertable through said hole for securing said light fixture to a mounting surface.

7. The electrical lighting system of claim 1 wherein said light fixture further comprises:
at least one lamp socket;
an attachment base for supporting said at least one lamp socket; and
a pivotable member attaching said at least one lamp socket to said attachment base to allow said at least one lamp socket to pivot relative to said attachment base.

8. The electrical lighting system of claim 1 wherein said light fixture further comprises:
at least one lamp socket; and
a shroud rotatably mounted on said light fixture partially covering each of said at least one lamp sockets and able to rotate relative to each of said at least lamp sockets to adjustably direct the light from said light fixture.

9. The electrical lighting system of claim 1 wherein said piercing points further include:
a portion extending perpendicular from said light fixture electrical leads.

10. The electrical lighting system of claim 1 wherein said at least one light fixture includes:
a flexible base member to allow adjustment of said at least one light fixture relative to said mounting surface.

11. An electrical lighting system wherein said system comprises:
two parallel electrical leads mounted in an insulative material;
an adhesive strip mounted on one surface of said insulative material to secure said insulative material to a mounting surface;
a power source for supplying electrical power to said two parallel electrical leads;
at least one light fixture;
electrically conductive leads extending from said at least one light fixture;
a connection mechanism for connecting said light fixture electrically conductive leads to said parallel electrical leads;
at least one lamp socket on each of said at least one light fixtures;
an attachment base for supporting said at least one lamp socket; and
a pivotable member attaching said at least one lamp socket to said attachment base to allow said at least one lamp socket to pivot relative to said attachment base.

12. The electrical lighting system of claim 11 wherein said system further comprises:
piercing points on said electrically conductive leads that pierce said insulative material to engage said two parallel electrical leads to provide electrical current from said two parallel electrical leads to said at least one light fixture.

13. The electrical lighting system of claim 11 wherein said system further comprises:
an attachment base on said light fixture for securing said light fixture to said insulative material.

14. The electrical lighting system of claim 11 wherein said system further comprises:
an attachment base on said light fixture for securing said light fixture to said insulative material; and
a non-conductive portion on said attachment base for protecting said piercing points in the event that said piercing points fully penetrate said insulative material.

15. The electrical lighting system of claim 11 wherein said system further comprises:
an attachment base on said light fixture for securing said light fixture to said insulative material; and
a non-conductive member pivotally attached to said attachment base for aligning and protecting said piercing points in the event that said piercing points fully penetrate said insulative material.

16. The electrical lighting system of claim 11 wherein said system further comprises:
an attachment base on said light fixture for securing said light fixture to said insulative material; and
an adhesive strip on said attachment base for securing said light fixture to a mounting surface.

17. The electrical lighting system of claim 11 wherein said system further comprises:
an attachment base on said light fixture for securing said light fixture to said insulative material;
a hole on said attachment base; and
a screw insertable through said hole for securing said light fixture to a mounting surface.

18. The electrical lighting system of claim 11 wherein said light fixture further comprises:
at least one lamp socket;
an attachment base for supporting said at least one lamp socket; and
a pivotable member attaching said at least one lamp socket to said attachment base to allow said at least one lamp socket to pivot relative to said attachment base.

19. The electrical lighting system of claim 11 wherein said light fixture further comprises:
at least one lamp socket; and
a shroud rotatably mounted on said light fixture partially covering each of said at least one lamp sockets and able to rotate relative to each of said at least lamp sockets to adjustably direct the light from said light fixture.

20. The electrical lighting system of claim 11 wherein said piercing points further include:
a portion extending perpendicular from said light fixture electrical leads.

21. The electrical lighting system of claim 11 wherein said light fixture further includes:
a flexible base to allow adjustment of said light fixture.

22. A method for installing a lighting system, said method comprising the steps of:
providing two parallel electrical leads mounted in an insulative material where the insulative material has an adhesive strip mounted on one surface of said insulative material to secure said insulative material to a mounting surface;
pressing the adhesive strip against a mounting surface to secure the insulative materials mounting the two parallel leads to the mounting surface;
connecting an electrical power source to the two parallel leads;
providing at least one light fixture having electrically conductive leads having piercing points extending from the at least one light fixture; and
inserting the piercing points through the insulative material until the piercing points engage the two parallel electrical leads to provide electrical current to the at least one light fixture.

23. The method of claim 21 wherein said step of inserting the piercing points through the insulative material further includes:
sliding a non-conductive member beneath the insulative material at the point beneath where the piercing points are inserted in the insulative material to prevent damage.

24. The method of claim 21 wherein said method further comprises the steps of:
providing at least one pivotable lamp socket on each of said at least one light fixtures;
pivoting said at least one pivotable lamp socket to direct light to a desired location.

25. The method of claim 21 wherein said method further comprises the steps of:
providing at least one rotatable lamp shroud on each of said at least one light fixture;
rotating said at least one rotatable lamp shroud to direct light to a desired location.
